(19) United States
(12) Patent Application Publication
(10) Pub. No.: US 2007/0279533 A1
(43) Pub. Date: Dec. 6, 2007

(54) Receiver apparatus

(75) Inventors: Yasuyuki Kasashima, Tokyo (JP); Toru Suda, Kanagawa (JP); Tsuyoshi Sakuma, Tokyo (JP); Hitoshi Masumura, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION

(21) Appl. No.: 11/801,866

(22) Filed: May 11, 2007

(30) Foreign Application Priority Data
Jun. 1, 2006 (JP) 2006-0153096

(51) Int. Cl. H04N 7/16; H04N 7/173; H04N 5/50

(52) U.S. Cl. 348/731; 725/100; 725/131; 725/139; 725/151

(57) ABSTRACT

A receiver apparatus for a television broadcasting wave includes a channel selection decision section configured to decide channel selection based on an intermediate frequency signal of a television broadcasting wave of a selected channel obtained by frequency conversion using a local oscillation signal. The channel selection decision section includes a frequency component extraction circuit and a decision section. The frequency component extraction circuit is configured to extract a frequency component to be used for the decision of channel selection including a frequency component within a band of the intermediate frequency signal. The decision section is configured to decide the presence/absence of a television broadcasting wave of the selected channel based on the level value of the frequency component extracted by the frequency component extraction circuit to perform decision of channel selection.

### CROSS REFERENCES TO RELATED APPLICATIONS

The present invention contains subject matter related to Japan Patent Application JP 2006-153096 filed with the Japan Patent Office on Jun. 1, 2006, the entire contents of which being incorporated herein by reference.

### BACKGROUND OF THE INVENTION

1. Field of the Invention

This invention relates to a receiver apparatus suitably incorporated in a mobile communications apparatus such as, for example, a portable telephone set.

2. Description of the Related Art

FIG. 5 is a block diagram showing a configuration of a typical receiver apparatus which can select a TV channel.

Referring to FIG. 5, the receiver apparatus shown includes an antenna inputting section 51, a high frequency amplification circuit 52, a mixing circuit 53, and a local oscillation circuit 54. The receiver apparatus further includes an IF (intermediate frequency) amplification circuit 55, an image detection circuit 56, an image processing circuit 57, a received image display section 58, a control circuit 59, a memory circuit 61 and a signal presence/absence decision section 62.

The antenna inputting section 51 receives a TV broadcasting wave and detects a high frequency signal of the TV broadcasting wave.

The high frequency amplification circuit 52 amplifies and outputs the high frequency signal of the TV broadcasting wave.

The mixing circuit 53 performs a mixing process of the amplified high frequency signal of the TV broadcasting wave and a local oscillation signal to produce an intermediate frequency signal.

The local oscillation circuit 54 produces and outputs the local frequency signal.

The IF amplification circuit 55 amplifies the image intermediate frequency signal.

The image detection circuit 56 produces a baseband signal from the amplified image intermediate frequency signal and outputs the baseband signal. FIG. 6 illustrates a waveform of the baseband signal.

The image processing circuit 57 extracts an image signal from the baseband signal and performs an image process for allowing the extracted image signal to be displayed on the received image display section 58.

The received image display section 58 displays a display apparatus of the LCD type or the plasma type for displaying an image.

The control circuit 59 controls components of the receiver apparatus including the local oscillation circuit 54 and the memory circuit 61.

The memory circuit 61 stores various data including preset data to be used for preset channel selection.

The signal presence/absence decision section 62 detects a horizontal synchronization signal of the baseband signal.

Now, operation of the receiver apparatus is described.

The present receiver apparatus carries out decision of whether or not a television channel exists upon television channel selection. The decision of presence or absence of a television channel is carried out, in the case of an analog television system, by decision by the signal presence/absence decision section 62 of whether or not the baseband signal outputted from the image detection circuit 56 includes a horizontal synchronization signal. If it is decided that a horizontal synchronization signal is included in the baseband signal, then the signal presence/absence decision section 62 outputs a horizontal synchronization signal verification signal to the control circuit 59. Thus, the control circuit 59 decides that channel selection is completed.

An automatic preset circuit is available as a circuit which carries out such decision of presence/absence of a television channel as described above and is disclosed, for example, in Japanese Patent Laid-open No. Hei 6-314958. In the automatic preset circuit, an AFT signal of an AFT circuit (automatic frequency adjustment circuit) of an IF amplification circuit is utilized such that it is decided from the level of the AFT signal whether or not the pertaining channel can be received. If the channel can be received, then the number of the receivable channel is stored into a memory, and down tuning is performed, thereby reducing the time required for automatic presetting.

### SUMMARY OF THE INVENTION

Accordingly, in selection of a television channel of a typical receiver apparatus, particularly in selection of a television channel of a receiver apparatus incorporated in a mobile apparatus, a trigger for the decision of presence/absence of a television channel upon television channel selection is normally given, for example, in the case of an analog television system, by a result of decision of presence/absence of a horizontal synchronization signal in a baseband signal outputted from an image detection circuit 56.

In the decision of presence/absence of a horizontal synchronization signal in a baseband signal, various processing circuits are used. A processing circuit for detecting a horizontal synchronization signal from a baseband signal and another processing circuit for confirming the horizontal synchronization signal detected by the preceding processing circuit are employed to decide whether or not a horizontal synchronization signal exists in the baseband signal to decide whether or not the television channel exists thereby to perform channel selection. As a result, there is a need to be solved that, particularly where the receiver apparatus is incorporated in a mobile apparatus which frequently moves through different service areas, it is demanded to perform selection of a television channel in short time.

Accordingly, it is desirable to provide a receiver apparatus wherein decision of whether or not broadcasting is proceeding in a selected channel can be made in short time thereby to perform selection of a television channel in short time.

According to an embodiment of the present invention, there is provided a receiver apparatus for a television broadcasting wave, including a channel selection decision section configured to decide channel selection based on an intermediate frequency signal of a television broadcasting wave of a selected channel obtained by frequency conversion using a local oscillation signal. The channel selection decision section includes a frequency component extraction circuit and a decision section. The frequency component extraction circuit is configured to extract a frequency component to be used for the decision of channel selection including a frequency component within a band of the intermediate frequency signal. The decision section is configured to decide the presence/absence of a television broadcasting wave of the selected channel based on the level value of the frequency component extracted by the frequency component extraction circuit to perform decision of channel selection.

With the receiver apparatus, the decision of whether or not a broadcast is being given in a selected channel can be made instantaneously. Consequently, the time required for selection of a television channel can be reduced, and selection of a television channel can be performed in short time.

### BRIEF DESCRIPTION OF THE DRAWINGS

FIG. 1 is a block diagram showing a configuration of a receiver apparatus to which the present invention is applied;

FIG. 2 is a waveform diagram illustrating a frequency spectrum of an intermediate frequency signal in an NTSC analog television broadcast;

FIG. 3 is a waveform diagram illustrating noise components appearing in a frequency band of the intermediate frequency signal where a broadcast is not being given;

FIG. 4 is a block diagram showing a configuration of another receiver apparatus to which the present invention is applied;

FIG. 5 is a block diagram showing a configuration of a typical receiver apparatus; and

FIG. 6 is a waveform diagram illustrating a baseband signal.

### DETAILED DESCRIPTION OF THE PREFERRED EMBODIMENTS

### First Embodiment

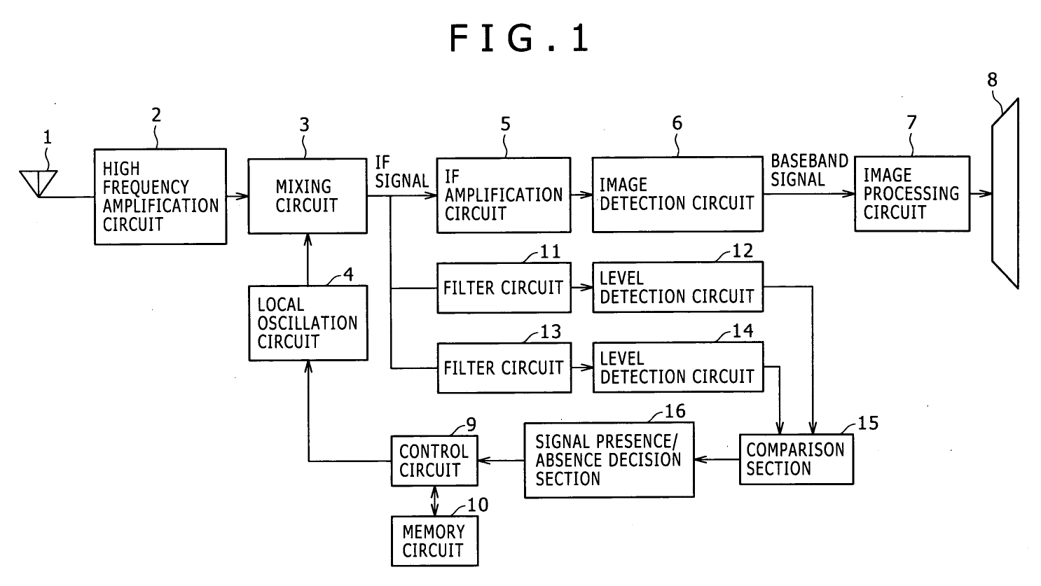

Referring to FIG. 1, there is shown a configuration of a receiver apparatus to which the present invention is applied.

FIG. 1 is a block diagram showing a configuration of a receiver apparatus to which the present invention is applied.

The receiver apparatus shown includes an antenna 1, a high frequency amplification circuit 2, a mixing circuit 3, a local oscillation circuit 4, an IF amplification circuit 5, an image detection circuit 6, an image processing circuit 7, and a received image display section 8. The receiver apparatus further includes a control circuit 9, a memory circuit 10, a first filter circuit 11, a second filter circuit 13, a first level detection circuit 12, a second level detection circuit 14, a comparison section 15, and a signal presence/absence decision section 16. The first filter circuit 11 and the second filter circuit 13 serve as channel selection decision means and a frequency component extraction circuit. The first level detection circuit 12, second level detection circuit 14, comparison section 15 and signal presence/absence decision section 16 serve as the channel selection decision means and a decision section.

The antenna 1 receives a TV broadcasting wave and detects a high frequency signal of the TV broadcasting wave.

The high frequency amplification circuit 2 amplifies and outputs the high frequency signal of the TV broadcasting wave.

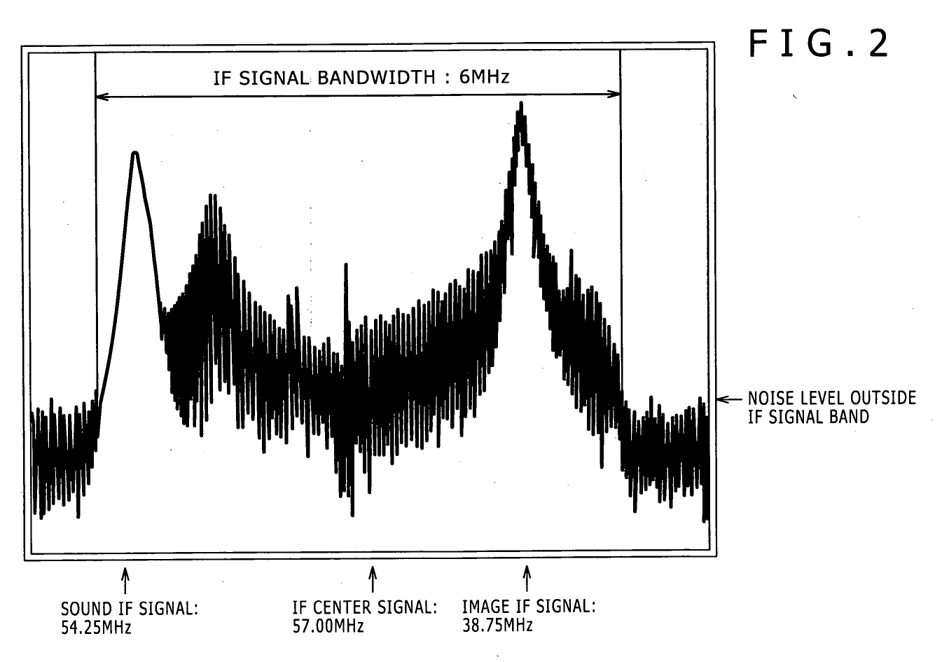

The mixing circuit 3 performs a mixing process of the amplified high frequency signal of the TV broadcasting wave and a local oscillation signal outputted from the local oscillation circuit 4 to produce an intermediate frequency signal IF illustrated in FIG. 2.

FIG. 2 illustrates a frequency spectrum of the intermediate frequency signal IF of an NTSC analog television signal used in Japan. The signal bandwidth of the intermediate frequency signal IF is 6 MHz, and the image intermediate frequency signal has a frequency of 58.75 MHz while a sound intermediate signal has another frequency of 54.25 MHz.

The local oscillation circuit 4 produces and outputs the local oscillation signal.

The IF amplification circuit 5 amplifies the intermediate frequency signal IF.

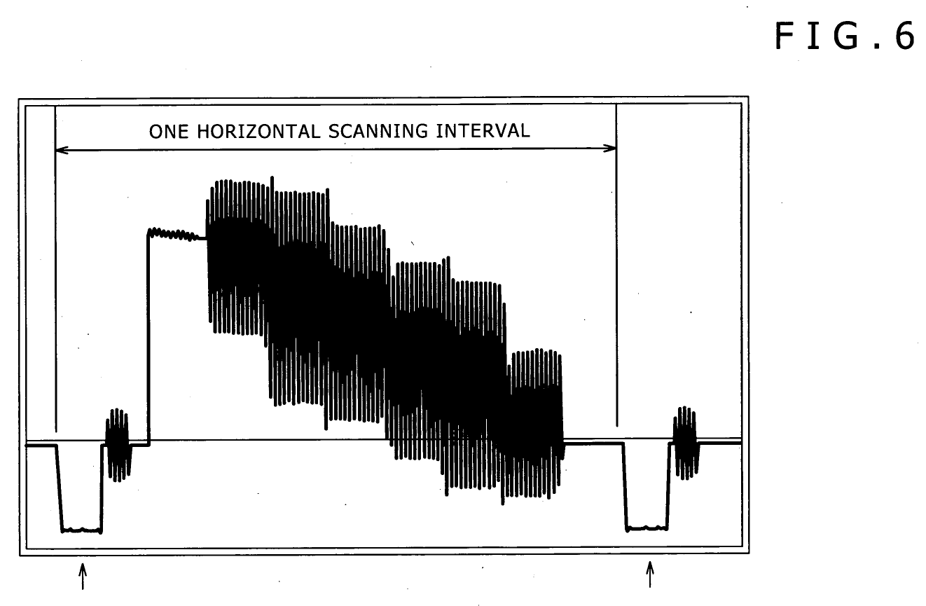

The image detection circuit 6 produces a baseband signal illustrated in FIG. 6 from the amplified intermediate frequency signal and outputs the produced baseband signal.

The image processing circuit 7 extracts an image signal from the baseband signal and performs an image process for the image signal for allowing the image signal to be displayed on the received image display section 8.

The received image display section 8 is a display apparatus of the LCD type or the plasma type for displaying an image.

The first filter circuit 11 extracts a predetermined frequency component. In order for the first filter circuit 11 to be ready for an NTSC analog television broadcast, the characteristic thereof is set so as to extract an image intermediate frequency signal of, for example, 58.75 MHz.

The first level detection circuit 12 detects the extracted image intermediate frequency signal of 58.75 MHz and extracts the level of the image intermediate frequency signal component as a voltage value.

The second filter circuit 13 extracts another predetermined frequency component. In order for the second filter circuit 13 to be ready for an NTSC analog television broadcast, the characteristic thereof is set to as to extract, for example, a signal component of a center signal of 57 MHz in the intermediate frequency signal IF of the bandwidth of 6 MHz.

The second level detection circuit 14 detects the extracted center signal of 57 MHz and extracts the level of the center signal component as a voltage value.

The comparison section 15 compares the voltage value of the image intermediate frequency signal component extracted by the first level detection circuit 12 with the voltage value of the center signal component extracted by the second level detection circuit 14. Then, the comparison section 15 outputs the level difference between the compared voltage values as a comparison result.

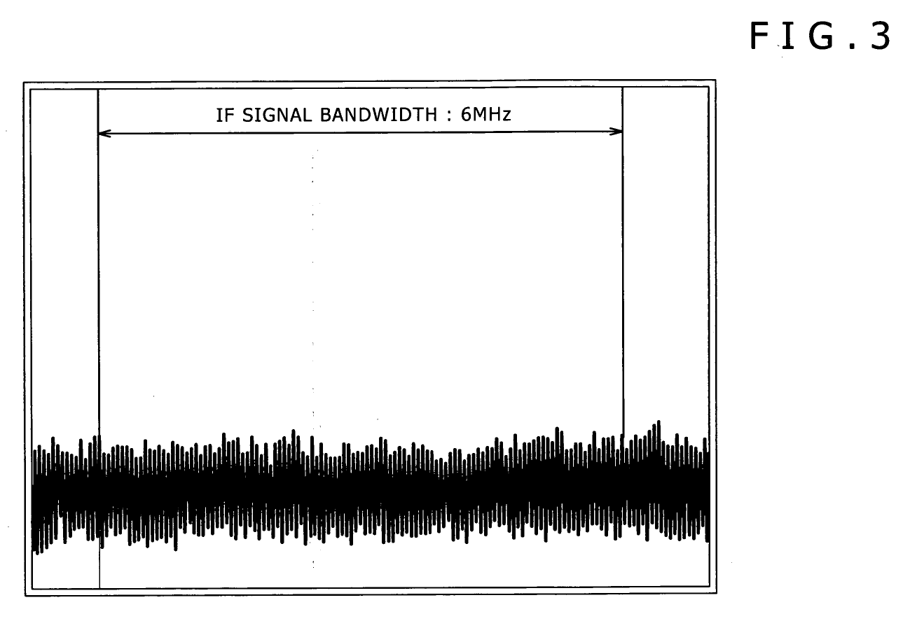

The signal presence/absence decision section 16 decides that, if the comparison result outputted from the comparison section 15 is equal to or higher than a fixed value, a broadcasting wave exists in the channel and a broadcast is being given in the channel. On the other hand, if no broadcasting wave exists in the channel and a broadcast is not being given in the channel, then the intermediate frequency signal IF includes only noise components. Therefore, the level difference outputted as the comparison result from the comparison section 15 is “0”. FIG. 3 illustrates noise components appearing in the frequency band of the intermediate frequency signal IF where a broadcast is not being given.

The control circuit 9 has an automatic preset channel selection function and controls components of the receiver apparatus including the local oscillation circuit 4 and the memory circuit 10. Further, the control circuit 9 stores a channel number with regard to which it is decided by the signal presence/absence decision section 16 that a broadcast is being given into the memory circuit 10. The memory circuit 10 stores various data including a channel number with regard to which it is decided by the signal presence/absence decision section 16 that a broadcast is being given.

Now, operation of the receiver apparatus is described.

In the receiver apparatus, it is decided whether or not a broadcast is being given in a selected television channel.

In the decision of whether or not a broadcast is being given in a selected television channel, where the receiver apparatus is an analog television apparatus, an image intermediate frequency signal component of 58.75 MHz is extracted by the first filter circuit 11 from the intermediate frequency signal IF illustrated in FIG. 2 outputted from the mixing circuit 3. Further, a signal component of a center signal of 57 MHz in the intermediate frequency signal IF is extracted by the second filter circuit 13.

Then, the voltage value of the image intermediate frequency signal component of 58.75 MHz extracted by the first filter circuit 11 is extracted by the first level detection circuit 12. Meanwhile, the voltage value of the signal component of the center signal of 57 MHz extracted by the second filter circuit 13 is extracted by the second level detection circuit 14.

Further, the voltage value of the image intermediate frequency signal component of 58.75 MHz and the voltage value of the signal component of the center signal of 57 MHz are compared with each other by the comparison section 15. Then, it is decided by the signal presence/absence decision section 16 whether or not the level difference between the voltage values is equal to or higher than the fixed value.

Then, if it is decided that the level difference is equal to or higher than the fixed value, then it is decided that a broadcasting wave exists in the channel and a broadcast is being given in the channel.

On the other hand, if the level difference is lower than the fixed value, then it is decided that no broadcasting wave exists in the channel and a broadcast is not being given in the channel.

It is to be noted that, when no broadcasting wave exists in the channel, since the level difference described above normally is “0”, it is possible to set the threshold value for the decision of whether or not a broadcasting wave exists in the channel to a value close to “0”.

If it is decided by the signal presence/absence decision section 16 that a broadcasting wave exists in the selected channel and a broadcast is being given in the channel, then the control circuit 9 stores the selected channel number as the number of the channel in which a broadcast is being given into the memory circuit 10.

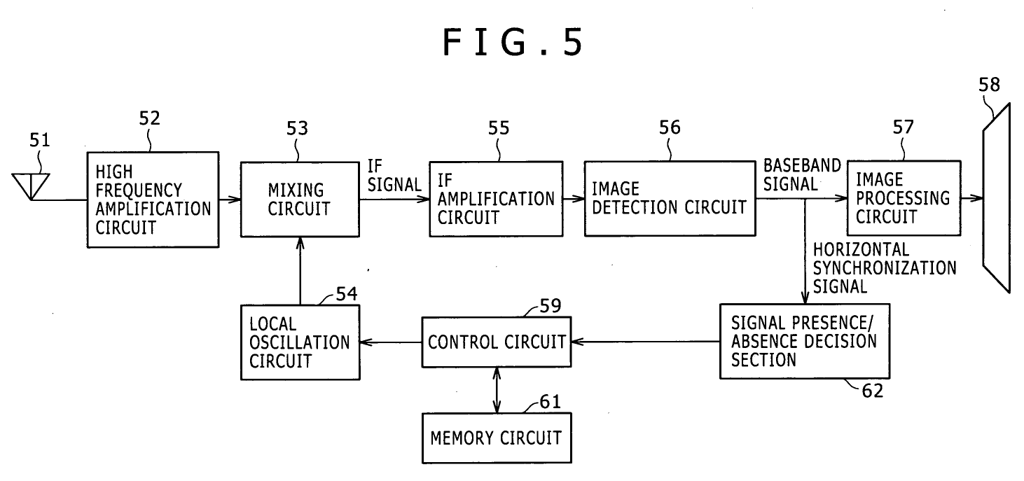

In the typical receiver apparatus described hereinabove with reference to FIG. 5, whether or not a horizontal synchronization signal of a baseband signal outputted from the image detection circuit 56 exists is decided by the signal presence/absence decision section 62 to decide whether or not a broadcasting wave exists in the selected channel and a broadcast is being given in the channel. In order for the signal presence/absence decision section 62 to decide such presence or absence of a horizontal synchronization signal with certainty, normally a period for the extraction of the horizontal synchronization signal and a synchronization period with a horizontal synchronization signal are demanded. Such a period for the extraction of a horizontal synchronization signal and a synchronization period with the extracted horizontal synchronization signal as just described are redundant periods when presence/absence of a horizontal synchronization signal is decided, and make a factor by which selection of a television channel may not be performed in short time.

In contrast, in the receiver apparatus of the present embodiment, an image intermediate frequency signal component of 58.75 MHz and a signal component of a center signal of 57 MHz are extracted from the intermediate frequency signal IF outputted from the mixing circuit 3. Then, it is decided from the level difference between the voltage values of the two signal components whether or not a broadcasting wave exists in the channel to be extracted and a broadcast is being given in the channel. Therefore, such redundant periods as in the typical receiver apparatus described above are not demanded, but the decision of whether or not a broadcast is being given in the channel can be performed instantaneously. Consequently, the receiver apparatus is advantageous in that the time demanded for selection of a television channel can be reduced and selection of a television channel can be performed in short time.

Further, in the receiver apparatus of the present embodiment, it is decided from the intermediate frequency signal IF outputted from the mixing circuit 3 whether or not a broadcasting wave exists in a selected channel and a broadcast is being given in the channel. In contrast, in the typical receiver apparatus described hereinabove with reference to FIG. 5, such decision is made based on a horizontal synchronization signal of a baseband signal outputted from the image detection circuit 56.

The intermediate frequency signal IF used in the receiver apparatus of the present embodiment to discriminate whether or not a broadcasting wave exists in a selected channel and a broadcast is being given in the channel is a signal closer to the antenna side than the baseband signal used in the typical receiver apparatus. This contributes to reduction of the time demanded for the decision of whether or not a broadcasting wave exists in a selected channel and a broadcast is being given in the channel. Accordingly, the receiver apparatus is advantageous in that the time demanded for selection of a television channel can be reduced and selection of a television channel can be performed in short time.

Further, not only in selection of a channel but also in automatic preset channel selection for the confirmation of presence/absence of all channels, the effect of reduction of time demanded for selection of a television channel is remarkable. The television receiver wherein the time demanded for selection of a television channel is reduced and selection of a television channel can be performed in short time is effective particularly where it is incorporated in a mobile apparatus such as a portable telephone set whose receiving area varies every moment.

### Modification to the First Embodiment

Now, a receiver apparatus according to a modification to the first embodiment of the present invention is described.

The receiver apparatus of the modification has the configuration described hereinabove with reference to FIG. 1 but is different in operation from the receiver apparatus of FIG. 1.

In particular, in the modified receiver apparatus, the second filter circuit 13 extracts a frequency component of, for example, 61 MHz outside the band of the intermediate frequency signal IF, and the second level detection circuit 14 extracts the level of the extracted frequency component of 61 MHz as a voltage value.

Then, the comparison section 15 compares the voltage value of the image intermediate frequency signal component of 58.75 MHz extracted by the first level detection circuit 12 with the voltage value of the frequency component of 61 MHz extracted by the second level detection circuit 14. Then, the comparison section 15 outputs the level difference between the voltage values as a comparison result.

If the level difference of the comparison result outputted from the comparison section 15 is equal to or higher than a fixed value, then the signal presence/absence decision section 16 decides that a broadcasting wave exists in the channel and a broadcast is being given in the channel. On the other hand, if the level difference is lower than the fixed value, then the signal presence/absence decision section 16 decides that a broadcasting wave does not exist in the channel and a broadcast is not being given in the channel.

It is to be noted that, also in the modified receiver apparatus, when no broadcasting wave exists in the channel, since the level difference described above normally is “0”, it is possible to set the threshold value for the decision of whether or not a broadcasting wave exists in the channel to a value close to “0”.

In the modified receiver apparatus, when a broadcasting wave exists in a selected channel and a broadcast is being given in the channel, the voltage value of the image intermediate frequency signal component of 58.75 MHz extracted by the first level detection circuit 12 is extracted as a certain value by the first level detection circuit 12.

At this time, although the voltage value of the frequency component of 61 MHz is extracted from the second level detection circuit 14, since the frequency component of 61 MHz is outside the band of the intermediate frequency signal IF, the extracted voltage value includes only noise components and hence is “0”.

The comparison section 15 compares the voltage value of the image intermediate frequency signal component of 58.75 MHz extracted by the first level detection circuit 12 with the voltage value of the frequency component of 61 MHz extracted by the second level detection circuit 14. Then, the comparison section 15 outputs the level difference between the voltage values as a comparison result. The signal presence/absence decision section 16 decides, when the comparison result outputted from the comparison section 15 is equal to or higher than the fixed value, that a broadcasting wave exists in the channel and a broadcast is being given in the channel.

In this manner, also with the receiver apparatus of the modification to the first embodiment, similar advantages to those of the receiver apparatus of the first embodiment can be achieved. In particular, the time demanded for selection of a television channel can be reduced and selection of a television channel can be performed in short time.

### Second Embodiment

Now, a second embodiment of the present invention is described.

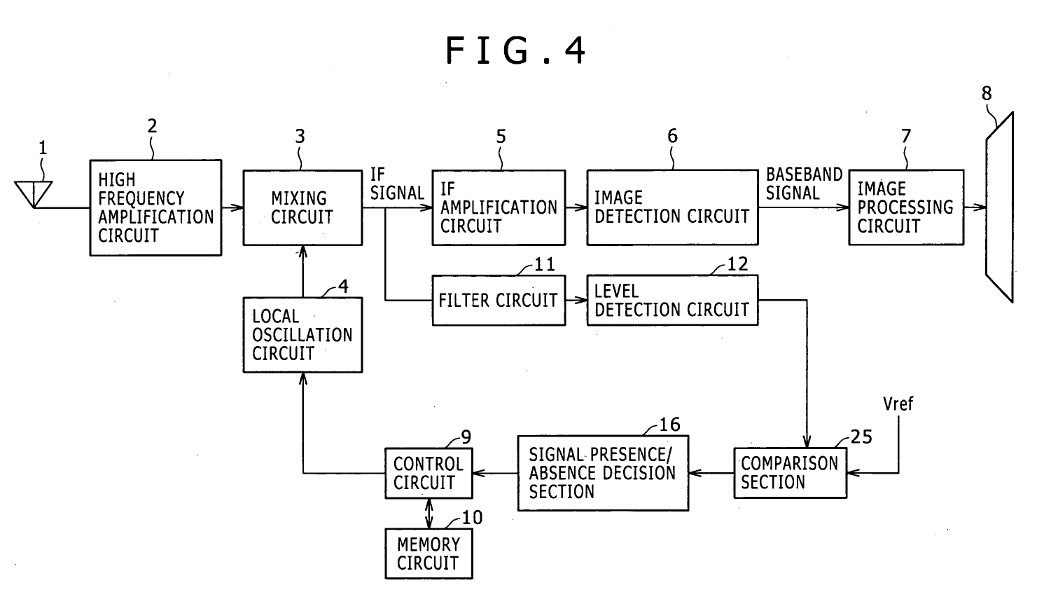

FIG. 4 shows a configuration of another receiver apparatus to which the present invention is applied.

Referring to FIG. 4, the receiver apparatus shown is a configuration to but is different from the receiver apparatus described hereinabove with reference to FIG. 1 in that it does not include the second filter circuit 13 and the second level detection circuit 14 and includes a comparison section 25 in place of the comparison section 15.

In the receiver apparatus of FIG. 4, the comparison section 25 compares the voltage value of an image intermediate frequency signal component of 58.75 MHz extracted by the first level detection circuit 12 with a voltage value Vref which is a fixed value. The voltage value Vref can be set, for example, to 0 V.

In the receiver apparatus of the second embodiment, if a broadcasting wave exists in a selected channel and a broadcast is being given in the channel, then the voltage value of the image intermediate frequency signal component of 58.75 MHz extracted by the first level detection circuit 12 is extracted as a certain value by the first level detection circuit 12.

The comparison section 25 compares the voltage value of the image intermediate frequency signal component of 58.75 MHz extracted by the first level detection circuit 12 with the fixed voltage value Vref and outputs the level difference between the voltage values as a comparison result. The signal presence/absence decision section 16 decides, if the comparison result outputted from the comparison section 25 is equal to or higher than the fixed value, that a broadcasting wave exists in the channel and a broadcast is being given in the channel.

It is to be noted that, also in the receiver apparatus of the second embodiment, when no broadcasting wave exists in the channel, the level difference described above normally is “0”.

In this manner, also with the receiver apparatus of the second embodiment, similar advantages to those of the receiver apparatus of the first embodiment can be achieved. In particular, the time demanded for selection of a television channel can be reduced and selection of a television channel can be performed in short time.

While the receiver apparatus described as the embodiments of the present invention above are each formed as a television receiver apparatus of the analog NTSC system used in Japan, the present invention can be applied also to television apparatus of the digital ISDB-T system or television apparatus which adopt a double conversion system as a channel selection system such as the analog PAL system or SECAM system used in other countries.

It should be understood by those skilled in the art that various modifications, combinations, sub-combinations and alterations may occur depending on design requirements and other factors insofar as they are within the scope of the appended claims or the equivalents thereof.

What is claimed is:

1. A receiver apparatus for a television broadcasting wave, comprising
channel selection decision means for deciding channel selection based on an intermediate frequency signal of a television broadcasting wave of a selected channel obtained by frequency conversion using a local oscillation signal,
said channel selection decision means including
a frequency component extraction circuit configured to extract a frequency component to be used for the decision of channel selection including a frequency component within a band of the intermediate frequency signal, and
a decision section configured to decide the presence/absence of a television broadcasting wave of the selected channel based on the level value of the frequency component extracted by said frequency component extraction circuit to perform decision of channel selection.

2. The receiver apparatus according to claim 1, wherein said frequency component extraction circuit includes a first filter circuit configured to extract a first frequency component within the band of the intermediate frequency signal and a second filter circuit configured to extract a second frequency component within the band of the intermediate frequency signal,
said decision section including a first level detection circuit configured to detect the level value of the first frequency component extracted by said first filter circuit, a second level detection circuit configured to detect the level value of the second frequency component extracted by said second filter circuit, a comparison section configured to compare the level value of the first frequency component detected by said first level detection circuit with the level value of the second frequency component extracted by said second level detection circuit, and a signal presence/absence decision section configured to decide the presence/absence of a television broadcasting wave of the selected channel based on a result of the comparison by said comparison section to perform the decision of channel selection.

3. The receiver apparatus according to claim 2, wherein the first frequency component extracted by said first filter circuit is a frequency component of an image intermediate frequency signal within the band of the intermediate frequency signal, and the second frequency component extracted by said second filter circuit is a frequency component of an intermediate frequency center signal at the center of the band of the intermediate frequency signal.

4. The receiver apparatus according to claim 2, wherein the first frequency component extracted by said first filter circuit is a frequency component of an image intermediate frequency signal within the band of the intermediate frequency signal, and the second frequency component extracted by said second filter circuit is a frequency component outside the band of the intermediate frequency signal.

5. The receiver apparatus according to claim 1, wherein said frequency component extraction circuit includes a first filter circuit configured to extract a first frequency component within the band of the intermediate frequency signal, and said decision section includes a first level detection circuit configured to detect the level value of the first frequency component extracted by said first filter circuit, a comparison section configured to compare the level value of the first frequency component detected by said first level detection circuit with a predetermined fixed value, and a signal presence/absence decision section configured to decide the presence/absence of a television broadcasting wave of the selected channel based on a result of the comparison by said comparison section to perform the decision of channel selection.

6. The receiver apparatus according to claim 5, wherein the first frequency component extracted by said first filter circuit is a frequency component of an image intermediate frequency signal within the band of the intermediate frequency signal.

7. A receiver apparatus for a television broadcasting wave, comprising
a channel selection decision section configured to decide channel selection based on an intermediate frequency signal of a television broadcasting wave of a selected channel obtained by frequency conversion using a local oscillation signal,
said channel selection decision section including
a frequency component extraction circuit configured to extract a frequency component to be used for the decision of channel selection including a frequency component within a band of the intermediate frequency signal, and
a decision section configured to decide the presence/absence of a television broadcasting wave of the selected channel based on the level value of the frequency component extracted by said frequency component extraction circuit to perform decision of channel selection.
